(19) United States
(12) Patent Application Publication
(10) Pub. No.: US 2015/0288321 A1
(43) Pub. Date: Oct. 8, 2015

(54) ROOFING SHINGLE INCLUDING A TRANSDUCER

(71) Applicant: Dale A. Schick, Haymarket, VA (US)

(72) Inventor: Dale A. Schick, Haymarket, VA (US)

(21) Appl. No.: 14/677,137

(22) Filed: Apr. 2, 2015

Related U.S. Application Data
(60) Provisional application No. 61/975,303, filed on Apr. 4, 2014.

(51) Int. Cl. H02S 20/25

(52) U.S. Cl. CPC H02S 20/25

(57) ABSTRACT

A transducer device includes a primary laminate, a secondary laminate, and a functional component. The primary laminate and the secondary laminate have a multi-layer structure, where two inner layers are a conductive mesh and a conductive foil. As assembled, a conductive fastener passes through the primary laminate and the secondary laminate and provides an electrical connection between the laminates. The functional component includes a flat transducer which is in connection with the laminates.

### CROSS-REFERENCE TO RELATED APPLICATIONS

This application claims the benefit of provisional patent application Serial No. 61/975,303, filed on Apr. 4, 2014.

### BACKGROUND OF THE INVENTION

The present disclosure relates generally to a roofing shingle including a transducer. More specifically, the present disclosure is directed to a roofing shingle that emulates a typical modular design, and includes a transducer configured to accumulate or utilize electrical energy.

Traditional roofing systems typically consist of a plurality of identical roofing shingles arranged in an overlapping pattern across the entire roof of a structure. In this manner, traditional shingles provide for both utility, such as protection from the environment, as well as aesthetic benefits.

However, as the result of volatile and generally increasing energy prices, and the subsequent increase in energy bills, there exists a market demand for energy consumers to be able to generate their own electricity, thus reducing net energy costs. Therefore, some consumers have turned to solar (also known as “photovoltaic”) panels to generate electricity.

Generally, a photovoltaic panel is a flat transducer that generates electricity in response to incident electromagnetic radiation, typically from incident sunlight. Such a panel consists of a plurality of individual photovoltaic cells, each of which contain a semiconductor layer that generates electron-hole pairs or excitons, which are extracted to external circuitry to thus generate electricity. The generation of electricity, then, is dependent on the amount of received light. Thus, to maximize the energy output, it is desirable to maximize the surface area of incident light.

In densely-populated urban and suburban areas, however, property lot sizes are comparatively small and the potential space for such photovoltaic panels is limited. Moreover, many consumers enjoy maintaining gardens, lawns, or other leisure spaces with their limited free space. Accordingly, a market has emerged for a solution which provides for the generation of energy using space which would otherwise not be utilized for any other purpose. Therefore, some related market offerings provide for the installation of photovoltaic panels on the roof of a dwelling or structure.

However, related market offerings suffer for several drawbacks. For example, many attempted solutions require engineered pre-assembly at a factory prior to installation. Such pre-assembled systems, in addition to being expensive to manufacture and assemble, are more difficult to ship. For example, if a single shingle in a pre-assembled system is damaged during shipping or storage, the entire system may need to be replaced.

Additionally, due to the delicate nature of the photovoltaic cells themselves, roofing professionals may need additional training and expertise, both in roofing systems and electrical systems, to properly handle and install such non-standard and/or proprietary shingle systems. This adds another layer of cost and inconvenience to the system.

Accordingly, there exists a need for a modular, weatherproof roofing system including a transducer such as a photovoltaic cell; specifically, a system that is easy to manufacture, assemble, and ship at low cost. Moreover, there exists a need for such a system to emulate traditional three-tab shingle systems to allow for ease of installation without specialized knowledge.

### BRIEF SUMMARY OF THE INVENTION

Various aspects of the present disclosure provide for a modular roofing shingle containing a transducer with no factory preassembly required. Such a system allows for easy repair and replacement of failed components without interrupting service from the remaining, working components. Roofing installers may install shingles according to various aspects of the present disclosure in a similar manner to traditional shingles. No specialized electrical training is necessary. Although various aspects of the present disclosure are illustrated with respect to a photovoltaic cell, the teachings of the present disclosure apply similarly to any flat transducer, such as a speaker or a display panel.

In one exemplary aspect, the present disclosure provides for a roofing shingle comprising: a secondary laminate including a positive conductor and a negative conductor; a functional component including a plurality of transducers; and a wiring connecting respective ones of the plurality of transducers to the positive and negative conductors, wherein the positive and negative conductors respectively include an upper insulating membrane, a conductive mesh, a conductive foil, and a lower insulating membrane.

In another exemplary aspect, the present disclosure provides for a roofing system comprising: a primary laminate including a positive primary conductor and a negative primary conductor; and a roofing shingle including: a secondary laminate including a positive secondary conductor and a negative secondary conductor; a functional component including a plurality of transducers; and a wiring connecting respective ones of the plurality of transducers to the positive and negative conductors, wherein the positive and negative primary conductors and the positive and negative secondary conductors respectively include an upper insulating membrane, a conductive mesh, a conductive foil, and a lower insulating membrane.

In yet another exemplary aspect, the present disclosure provides for a method of installing a roofing system comprising: providing a primary laminate including a positive primary conductor and a negative primary conductor; providing a roofing shingle including: a secondary laminate including a positive secondary conductor and a negative secondary conductor; a functional component including a plurality of transducers; and a wiring connecting respective ones of the plurality of transducers to the positive and negative conductors; making an electrical connection between the positive primary conductor and the positive secondary conductor, or between the negative primary conductor and the negative secondary conductor, by providing a fastener, wherein the positive and negative primary conductors and the positive and negative secondary conductors respectively include an upper insulating membrane, a conductive mesh, a conductive foil, and a lower insulating membrane.

Moreover, various aspects of the present disclosure may further be provided wherein the conductive mesh includes a plurality of mesh openings according to the relation d₁<d₂≦1.05d₁, where d₁ is a distance between adjacent wires of the conductive mesh and d₂ is a diameter of a roofing nail.

The present disclosure may be embodied in various forms. The foregoing summary is intended merely to provide a general overview of various aspects of the present disclosure, and is not intended to limit the scope of this application in any way.

### BRIEF DESCRIPTION OF THE DRAWINGS

These and other more detailed and specific features of the above aspects are more fully disclosed in the following specification, reference being had to the accompanying drawings, in which:

FIG. 1 illustrates an exemplary structure according to various aspects of the present disclosure;

FIG. 2 illustrates an exemplary transducer device according to various aspects of the present disclosure;

FIG. 3 is a detailed view of the exemplary transducer device according to FIG. 2;

FIG. 4 illustrates an exemplary conductive laminate according to various aspects of the present disclosure;

FIG. 5 illustrates an exemplary configuration of a plurality of transducer devices according to various aspects of the present disclosure;

FIG. 6A illustrates an exemplary connection between an exemplary transducer device and an exemplary conductive laminate according to various aspects of the present disclosure, prior to installation; and

FIG. 6B illustrates an exemplary connection between an exemplary transducer device and an exemplary conductive laminate according to various aspects of the present disclosure, after installation.

### DETAILED DESCRIPTION

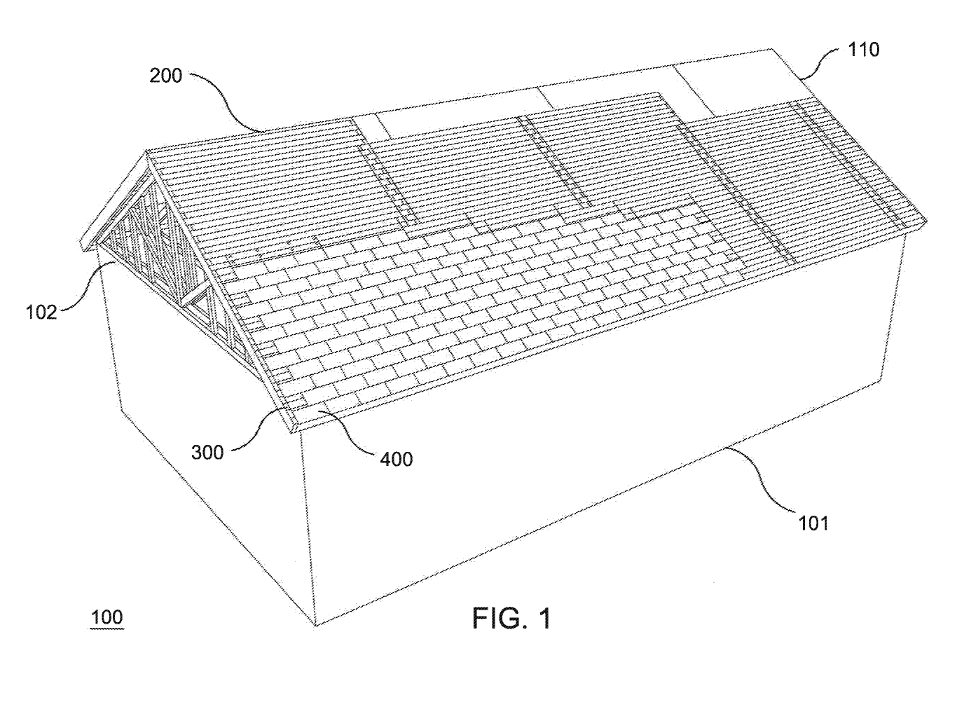

FIG. 1 illustrates an exemplary structure 100 according to various aspects of the present disclosure. Structure 100 is preferably a building, such as a residential, commercial, industrial, or mixed-use building, a tool shed, a barn, a kiosk, a gazebo, a billboard, and the like. Structure 100 may also be a mobile structure, such as a mobile home, a recreational vehicle, a food truck, and the like. For purposes of illustration with regard to exemplary FIG. 1, structure 100 will be described as a residential building; that is, a house.

Structure 100 includes a base 101 and a roof 102, wherein roof 102 is supported by base 101. As illustrated in FIG. 1, roof 102 covers an interior space bounded by base 101; however, in various aspects of the present disclosure roof 102 may include an overhang which covers an exterior space external to the base 101. Furthermore, although FIG. 1 illustrates roof 102 having an angled orientation, in various aspects of the present disclosure roof 102 may be a flat surface, a curved surface, or a combination of flat, curved, and angled surfaces.

Roof 102 includes a substrate 110. Substrate 110 is preferably a thin, flat surface which extends across substantially the entire dimension of roof 102. Substrate 110 may be supported by base 101 and/or a support structure (not shown), such as a pillar, internal wall, and/or a crossbeam. Substrate 110 may comprise one or a plurality of layers. The material of substrate 110 is not particularly limited; for example, substrate 110 may comprise plywood, strand board, fiberglass, and the like. Substrate 110 may alternatively be a composite substrate including a material configured to prevent voltage leaks through semi-conductive plywood or strand board substrate layers. Although not explicitly illustrated, roof 102 may additionally include an insulating material on the underside of substrate 110 to prevent electrical contact with fasteners (such as fastener 501 as will be described in more detail below).

Roof 102 further includes a transducer device including a primary laminate 200, a secondary laminate 300, and a functional component 400, such as a transducer. Primary laminate 200 serves as a conductor for the system according to various aspects of the present disclosure. In this manner, primary laminate 200 is preferably configured to deliver power and/or control signals between functional component 400 and a central unit (not shown), such as a battery, a power grid, a computer, and the like.

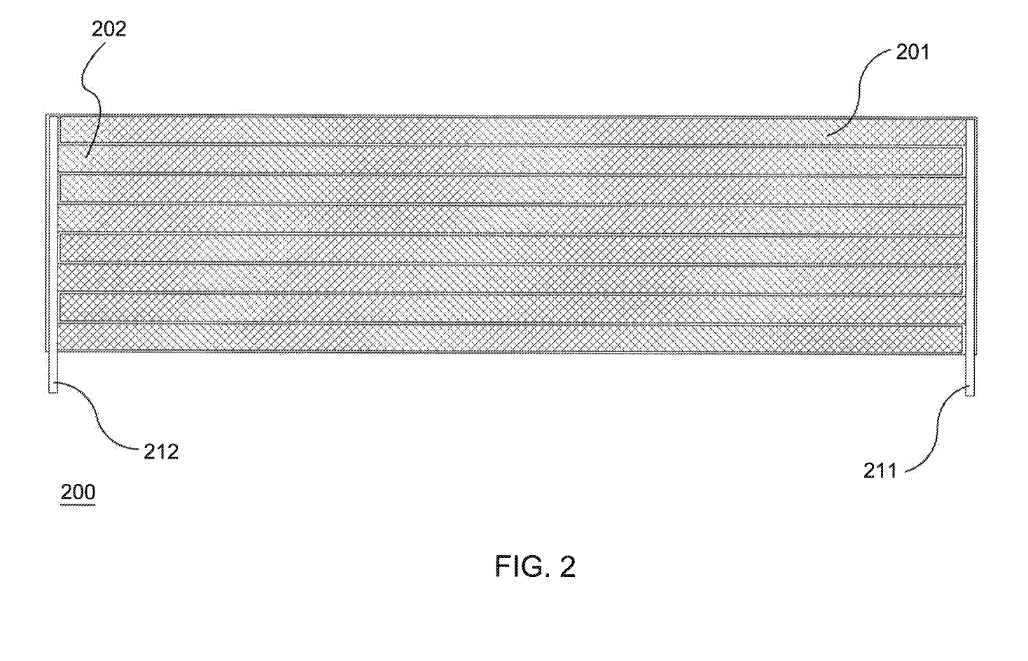

Primary laminate 200 is illustrated in more detail with regard to FIG. 2. As illustrated in FIG. 2, primary laminate 200 includes a plurality of alternating positive conductors 201 and negative conductors 202. Conductors 201, 202 are disposed in a parallel interleaved arrangement, and are further disposed such that adjacent conductors 201, 202 are electrically isolated from one another. This electrical isolation may be accomplished by leaving a sufficient space between adjacent conductors 201, 202 and/or by providing an insulating layer between adjacent conductors 201, 202.

A positive terminal strip 211 and a negative terminal strip 212 are respectively disposed at opposite ends of primary laminate 200. Positive terminal strip 211 is preferably electrically connected to each positive conductor 201, and negative terminal strip 212 is preferably electrically connected to each negative conductor 202. Terminal strips 211, 212 conduct power and/or control signals between conductors 201, 202 and the above-described central unit at a connector end. Although FIG. 2 illustrates the connector end as disposed at an end of primary laminate 200, the connector end may additionally or alternatively be located at an intermediate portion of primary laminate 200.

Primary laminate 200 may extend from one end of roof 102 to the other; however, primary laminate 200 is preferably formed in subsections wherein each subsection is bounded by respective terminal strips 211, 212, as shown in FIG. 1. Specifically, if conductors 201, 202 are too long, conductivity and signal fidelity may be compromised and failure of one or more conductors may lead to high replacement costs. By incorporating a plurality of primary laminates 200 in subsections, high conductivity and improved modularity may be realized.

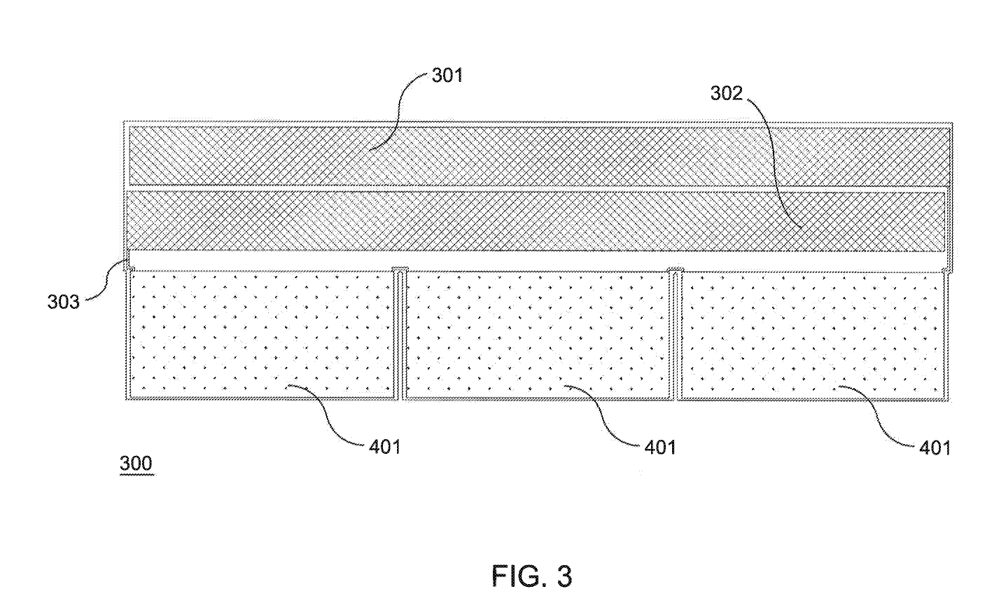

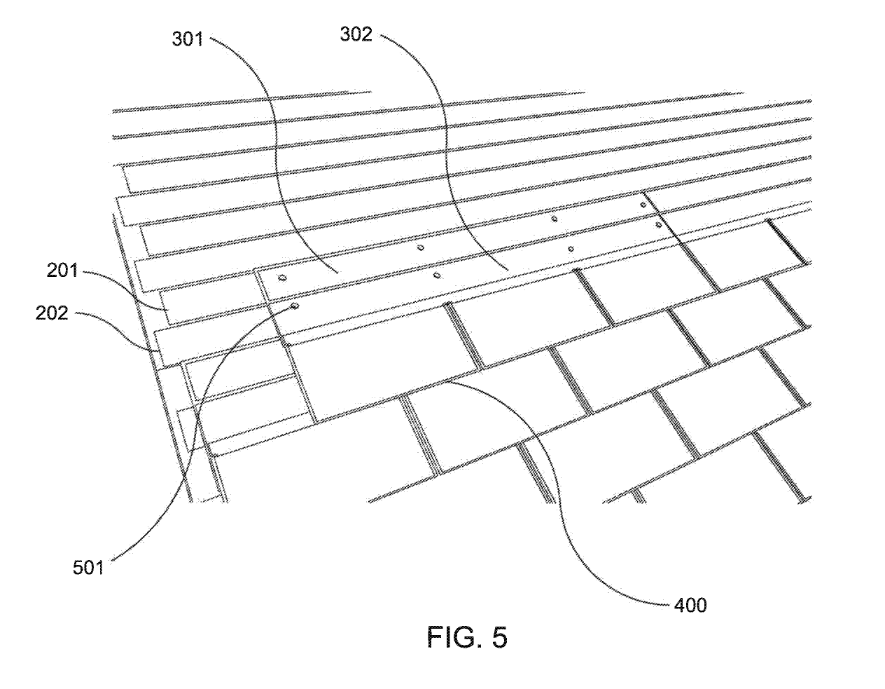

Secondary laminate 300 and functional component 400 are illustrated in more detail with regard to FIG. 3. FIG. 3 shows an exemplary configuration wherein secondary laminate 300 and functional component 400 are provided in a three-tab shingle arrangement, where a transducer 401 is provided on each of the three tab sections. Alternatively, secondary laminate 300 and functional component 400 may be provided in any other shingle arrangement, such as architectural or designer shaped shingles. As will be described in more detail below, secondary laminate 300 may be attached to primary laminate 200 by a fastener 501 (see FIG. 5), such that a conductor 301 is electrically connected to a conductor 201, and a conductor 302 is electrically connected to a conductor 202.

In the three-tab arrangement shown in FIG. 3, each individual shingle includes a secondary laminate 300 and a functional component 400 comprising three transducers 401. Secondary laminate 300 preferably comprises a positive conductor 301 and a negative conductor 302. Conductors 301, 302 are disposed in a parallel arrangement, and are further disposed such that adjacent conductors 301, 302 are electrically isolated from one another. This electrical isolation may be accomplished by leaving a sufficient space between adjacent conductors 301, 302 and/or by providing an insulating layer between adjacent conductors 301, 302. A shingle further includes internal wiring 303 connecting transducers 401 to conductors 301, 302 to deliver power and/or control signals therebetween. Furthermore, the shingle may include lightning protection and/or grounding circuits to provide additional protection in storm-prone locations.

Transducer 401 may be any flat-type transducer capable of converting one form of energy to another. For example, transducer 401 may be a photovoltaic cell capable of receiving radiation energy and generating electricity therefrom. Furthermore, transducer 401 may be a display unit capable of receiving electricity and emitting light based thereon. Still further, transducer 401 may be a flat speaker capable of receiving electricity and converting into acoustical energy (sound waves). A functional component 400 of a shingle may include three transducers 401 of the same type, or a combination of transducers of different types. Additionally or alternatively, each shingle may have the same or a different transducer configuration. For example, one portion of roof 102 may be configured as a photovoltaic section comprising photovoltaic transducers 401, while a separate portion of roof 102 may be configured as a display section comprising display transducers 401. In such a configuration, in addition or alternative to being connected to a central unit as described above, conductors 201, 202, 301, 302 corresponding to different sections may be connected to one another; for example, to provide power from a photovoltaic section to a display section and/or an acoustical section, thereby providing a self-contained system.

Where the transducer 401 is a photovoltaic cell, transducer 401 may comprise any flat device capable of absorption of incident electromagnetic radiation to generate electron-hole pairs or excitons and thus generate electricity. For example, transducer 401 may include a multijunction cell, a single-junction cell, a crystalline silicon cell, a thin-film cell, a quantum dot cell, a plasmonic solar cell, and the like.

Where the transducer 401 is a display unit, transducer 401 may comprise any output device for presentation of information in a visual form. For example, transducer 401 may include a light-emitting diode (LED) display, an electroluminescent display, electronic paper, a plasma display panel (PDP), a liquid crystal display (LCD), a field-emission display (FED), a thin-film transistor (TFT) display, an organic light-emitting diode display (OLED), surface-conduction electron-emitter display (SED), a laser display, a quantum dot display, an interferometric modulator display, and the like. In such a configuration, transducer 401 may comprise an array of pixels to provide high-resolution display; alternatively, transducer 401 may comprise a single pixel to provide low-resolution display.

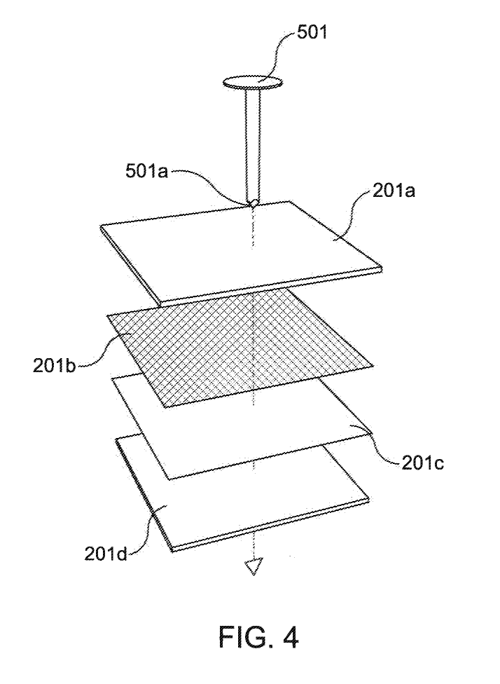

FIG. 4 illustrates an exemplary conductive laminate according to various aspects of the present disclosure. For purposes of illustration, the conductive laminate of FIG. 4 will be provided with reference to conductor 201; however, conductors 202, 301, 302 preferably have a similar structure.

As illustrated in FIG. 4, conductor 201 comprises a plurality of stacked layers. For example, conductor 201 may comprise an upper membrane 201a, a mesh 201b, a foil 201c, and a lower membrane 201d. Preferably, upper membrane 201a and lower membrane 201d are formed of an electrically insulating material, whereas mesh 201b and foil 201c are formed of an electrically conducting material. In this manner, mesh 201b and foil 201c may conduct electrical signals, including power and/or control signals as described above, while upper membrane 201a and lower membrane 201d may electrically isolate each conductor 201 from an adjacent conductor 202. Similarly, although not expressly illustrated, conductor 301 preferably comprises an upper membrane 301a, a mesh 301b, a foil 301c, and a lower membrane 301d.

Although FIG. 4 illustrates conductor 201 as having four stacked layers, the present disclosure is not so limited. For example, conductor 201 may include additional layers to maintain connection stability while retaining the degree of flexibility commonly associated with standard roofing shingles. For example, adhesive layers may be included between the above-described layers to avoid delamination of the conductor during manufacture and/or installation. For example, a conductive adhesive may be provided between mesh 201b and foil 201c, a nonconductive adhesive may be provided between upper membrane 201a and mesh 201b, and/or a nonconductive adhesive may be provided between foil 201c and lower membrane 201d.

Furthermore, additional conductive layers (such as additional conductive meshes and/or additional conductive foils) may be provided to ensure adequate coverage and power distribution across the entire roof surface.

Preferably, upper membrane 201a and/or lower membrane 201d are formed of a material having very low electrical conductivity, such as felt, glass fiber asphalt composite, tar-paper, or plastic laminate.

Furthermore, mesh 201b and/or foil 201c are preferably formed of a material having high electrical conductivity, such as copper, aluminum, nickel, or zinc-coated copper. Most preferably, mesh 201b and/or foil 201c are formed of a combination of materials that are resistant to electrolytic corrosion by virtue of matching the electropotential of said materials with that of a conductive fastener 501.

In order to provide electrical connection between a conductor 201 and a conductor 301 (or between a conductor 202 and a conductor 302), at least one fastener 501 is provided. Fastener 501 is a conductive fastener such as a galvanic nail or the like. As illustrated in FIG. 4, fastener 501 includes a piercing portion 501a configured to pierce at least upper membrane 201a, mesh 201b, and foil 201c. As illustrated in FIG. 5, fastener 501 preferably passes through a pair of vertically adjacent conductors, such that the piercing portion 501a pierces upper membrane 301a, mesh 301b, foil 301c, lower membrane 301d, upper membrane 201a, mesh 201b, and foil 201c. Because fastener 501 is a conductive fastener, electrical connection can be made between mesh 301b and foil 301c, and mesh 201b and foil 201c. In this manner, conductors 201 and 301 may be electrically connected to one another.

Fastener 501 may be formed of the same material as mesh 201b and/or foil 201c, and is only substantially limited in that piercing portion 501a of fastener 501 must be formed of a conductive material. For example, piercing portion 501a may be formed of copper, aluminum, nickel, or zinc-coated (galvanized) steel. Most preferably, fastener 501 including piercing portion 501a is formed of a material that is resistant to electrolytic corrosion.

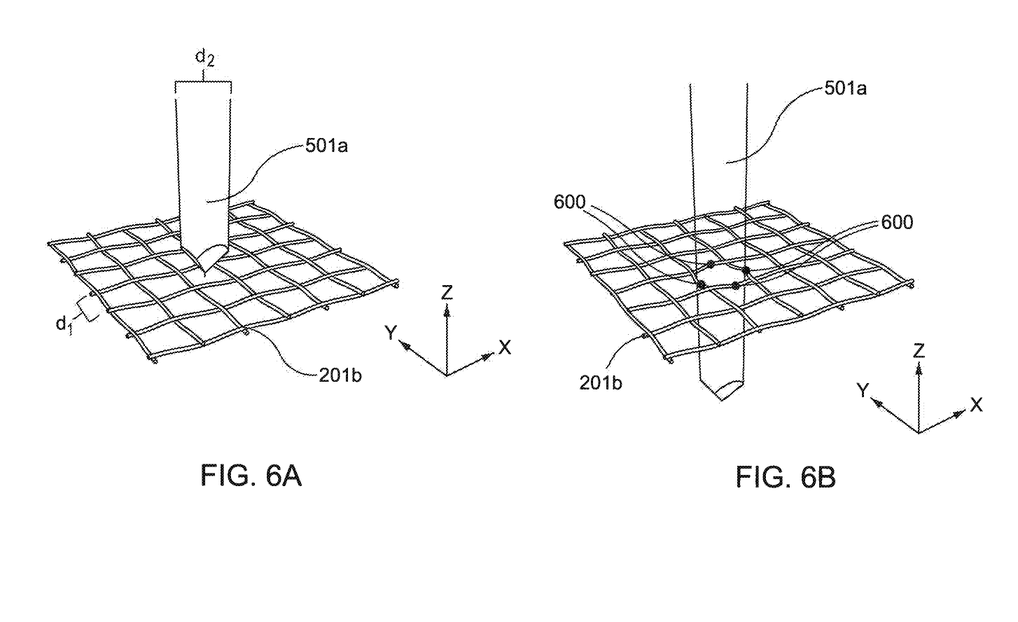

FIGS. 6A-B illustrate exemplary positional relationships between piercing portion 501a and mesh 201b before and after installation, respectively, with other layers of conductor 201 eliminated solely for clarity of description. That is, FIG. 6A illustrates a relationship between fastener 501 and conductor 201 immediately prior to the installation of fastener 501, and FIG. 6B illustrates a relationship between fastener 501 and conductor 201 after the installation of fastener 501.

As illustrated in FIGS. 6A-B, mesh 201b (and similarly, mesh 301b) is a regularly-repeating square mesh formed of a plurality of wires extending in the X- and Y- directions. Alternatively, mesh 201b and/or mesh 301b may be a double-weave mesh having two or more layers of wires extending in the X- and/or Y-directions and interwoven to form a multi-layer mesh. In either configuration, each adjacent wire in the X-Y plane is separated by a distance d₁, such that the mesh 201b comprises a plurality of mesh openings having mesh size d₁×d₁. Preferably, the wires comprising mesh 201b are connected with an amount of slack to provide for degree of freedom in the transverse direction; for example, slack sufficient to allow for transverse displacement of no more than 10% of d₁ between adjacent wires, preferably no more than 5% of d₁.

As further illustrated in FIGS. 6A-B, piercing portion 501a is a columnar protrusion extending in the Z-direction. Piercing portion 501a has an outer diameter d₂ in the X-Y plane. Preferably, piercing portion 501a has an outer diameter larger than the mesh size of mesh 201b to ensure electrical connection; that is, d₁<d₂<1.05d₁.

When fastener 501 is installed, as shown in FIG. 6B, piercing portion 501a contacts mesh 201b at primary contact points 600. Because the outer diameter of piercing portion 501a and the mesh size of mesh 201b are preferably equal, piercing portion 501a and mesh 201b preferably have an electrical connection therebetween at four contact points 600. Realistically, however, there is some variation in outer diameter among different fasteners 501. In view of the degree of slack described above, however, mesh 201b is capable of remedying these manufacturing variations and ensuring electrical connection at a plurality of contact points 600.

In this manner, a good connection between fastener 501 and conductor 201 (or 301) is ensured. Because fastener 501 passes through both conductor 201 and conductor 301, and because both conductors 201, 301 include meshes 201b, 301b, a similarly good connection can be ensured between conductor 201 and conductor 301.

Furthermore, by the multilayer configuration of respective conductors 201, 301 (that is, because conductors 201, 301 also include foils 201c, 301c), low resistance may additionally be achieved. In other words, were conductor 201 to not include a mesh 201b, it would be difficult to make a good electrical connection between fastener 501 and conductor 201, and thereby be difficult to make a good electrical connection between vertically-adjacent conductors 201, 301. Similarly, were conductor 201 to not include a foil 201c, conductor 201 would cause large resistive losses along a length direction thereof, even if a reliable connection between vertically-adjacent conductors 201, 301 were achieved.

Installation of the system can be achieved by using conventional roofing installation methods. Markings on the upper layer of both primary/secondary laminates will outline the positive and negative contact points as well as areas for which fasteners should not be installed such as near internal wiring 303. By aligning primary laminate 200 onto the leading edge of substrate 110 and overlapping all subsequent sections from the bottom of roof 102 to the top and using fastener 501 at each overlapping portion of 201 and 202, a full covering is achieved for which to install the secondary laminate 300. Each iteration of 300 can be installed by aligning color coded markings on the primary and secondary laminates and fastening with a number of fasteners 501 making contact between 301/201, 302/202. The positive and negative contacts for making the final electrical connections may be terminated with strips 211 and 212 at either end of roof 102 by affixing with fastener 501 at all points where the strip meets the conductive portion 201 and 202. The end of the strip will effectively make a parallel connection of all functional components and can be connected to a power integration system similar to any residential solar system. FIG. 5 illustrates the system in at an intermediate stage of such an exemplary installation method.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A roofing shingle comprising:
a secondary laminate including a positive conductor and a negative conductor;
a functional component including a plurality of transducers; and
a wiring connecting respective ones of the plurality of transducers to the positive and negative conductors,
wherein the positive and negative conductors respectively include an upper insulating membrane, a conductive mesh, a conductive foil, and a lower insulating membrane.

2. The roofing shingle according to claim 1, wherein the respective ones of the plurality of transducers are selected from a group consisting of a photovoltaic cell, a display unit, and a speaker.

3. The roofing shingle according to claim 1, wherein the conductive mesh includes a plurality of mesh openings according to the relation d₁<d₂<1.05d₁, where d₁ is a distance between adjacent wires of the conductive mesh and d₂ is a diameter of a roofing nail.

4. The roofing shingle according to claim 1, wherein the positive conductor and the negative conductor are electrically isolated from one another.

5. The roofing shingle according to claim 1, wherein the positive and negative conductors respectively include at least one adhesive layer.

6. The roofing shingle according to claim 1, wherein the secondary laminate includes a color-coded marking.

7. A roofing system comprising:
a primary laminate including a positive primary conductor and a negative primary conductor; and a roofing shingle including:
a secondary laminate including a positive secondary conductor and a negative secondary conductor;
a functional component including a plurality of transducers; and
a wiring connecting respective ones of the plurality of transducers to the positive and negative conductors,
wherein the positive and negative primary conductors and the positive and negative secondary conductors respectively include an upper insulating membrane, a conductive mesh, a conductive foil, and a lower insulating membrane.

8. The roofing system according to claim 7, wherein the respective ones of the plurality of transducers are selected from a group consisting of a photovoltaic cell, a display unit, and a speaker.

9. The roofing system according to claim 7, wherein the conductive mesh includes a plurality of mesh openings according to the relation d₁<d₂<1.05d₁, where d₁ is a distance between adjacent wires of the conductive mesh and d₂ is a diameter of a roofing nail.

10. The roofing system according to claim 7, wherein the positive secondary conductor and the negative secondary conductor are electrically isolated from one another.

11. The roofing system according to claim 7, wherein the positive and negative primary conductors and the positive and negative secondary conductors respectively include at least one adhesive layer.

12. The roofing system according to claim 7, wherein the secondary laminate includes a color-coded marking.

13. The roofing system according to claim 7, wherein the primary laminate includes a positive terminal strip and a negative terminal strip.

14. The roofing system according to claim 13, wherein the positive terminal strip is electrically connected to the positive primary conductor and the negative terminal strip is electrically connected to the negative primary conductor.

15. The roofing system according to claim 7, wherein the positive terminal strip and the negative terminal strip are electrically connected to a central unit.

16. The roofing system according to claim 7, further comprising a fastener configured to make an electrical connection between the positive primary conductor and the positive secondary conductor, or between the negative primary conductor and the negative secondary conductor.

17. The roofing system according to claim 16, wherein the fastener includes a piercing portion formed of a material that is resistant to electrolytic corrosion.

18. A method of installing a roofing system comprising:
providing a primary laminate including a positive primary conductor and a negative primary conductor;
providing a roofing shingle including:
a secondary laminate including a positive secondary conductor and a negative secondary conductor;
a functional component including a plurality of transducers; and
a wiring connecting respective ones of the plurality of transducers to the positive and negative conductors;
making an electrical connection between the positive primary conductor and the positive secondary conductor, or between the negative primary conductor and the negative secondary conductor, by providing a fastener,
wherein the positive and negative primary conductors and the positive and negative secondary conductors respectively include an upper insulating membrane, a conductive mesh, a conductive foil, and a lower insulating membrane.
